(19) United States
(12) Patent Application Publication
(10) Pub. No.: US 2010/0193332 A1
(43) Pub. Date: Aug. 5, 2010

(54) CONVEYING SYSTEM FOR TRANSPORTING MATERIALS, IN PARTICULAR BULK MATERIAL

(75) Inventors: Jurgen Beyerer, Dielheim (DE); Kai-Uwe Vieth, Karlsruhe (DE)

Correspondence Address: SCHWEGMAN, LUNDBERG & WOESSNER, P.A., P.O. BOX 2938, MINNEAPOLIS, MN, 55402, US

(73) Assignee: Fraunhofer-Gesellschaft zur Forderung der Angewandten Forschung E.V., Munchen (DE)

(21) Appl. No.: 12/694,362

(22) Filed: Jan. 27, 2010

(30) Foreign Application Priority Data
Jan. 30, 2009 (DE) 10 2009 007 481.3

(51) Int. Cl. B65G 15/14

(52) U.S. Cl. 198/604

(57) ABSTRACT

A conveying system for transporting materials, in particular bulk material, can comprise a first conveying element which is configured to receive the materials and to transport the same in a transport direction and can be moved in the same direction in the transport direction. A second conveying element which can be moved in the transport direction and is disposed at a spacing from the first conveying element. The second conveying element is provided with a plurality of transverse ribs which can be moved with the second conveying element in the transport direction, which transverse ribs are formed and disposed on the second conveying element such that they cover the first conveying element on the side thereof configured to receive the materials and, together with the latter side of the first conveying element, form compartments which are separated from each other in order to receive and transport the materials.

### CLAIM OF PRIORITY

The present patent application claims the priority benefit of the filing date of German Patent Application No. 10 2009 007 481.3, filed Jan. 30, 2009, the entire content of which is incorporated herein by reference in its entirety.

The present document relates to a conveying system for transporting materials (in particular bulk material) according to claim 1 and also to a corresponding conveying method for transporting materials according to claim 16.

Bulk materials, such as for example plastic material granulates, minerals or ores, are supplied to machines via chutes, vibration channels or conveyor belts which further process the bulk material within the scope of processing and refining. If such bulk materials are intended to be tested or measured in one of these processes by means of for example an optical sensor which is disposed perpendicular to the transport direction directly after discharge from a horizontally running conveyor belt, then it is desired for evaluation and sorting that the bulk materials lie as still as possible on the conveyor belt and the transport speed of the bulk materials is constant over the entire width of the conveyor belt at the time of discharge.

In particular with bulk materials with a low specific weight or with a low specific density (such as for example cut materials in the form of tobacco or spices), this precondition can only be fulfilled with great difficulty because of the weight or the density and/or the shape: if the bulk materials have a very low density, then the individual objects are guided past the visual range of the optical sensor at variable speeds.

The aim of the bulk material sorting, to test bulk materials for their quality, in order to recognise consequently the difference of good bulk material from poor bulk material and in most cases then to implement also a corresponding separation, can hence only be achieved with difficulty for bulk materials with low density.

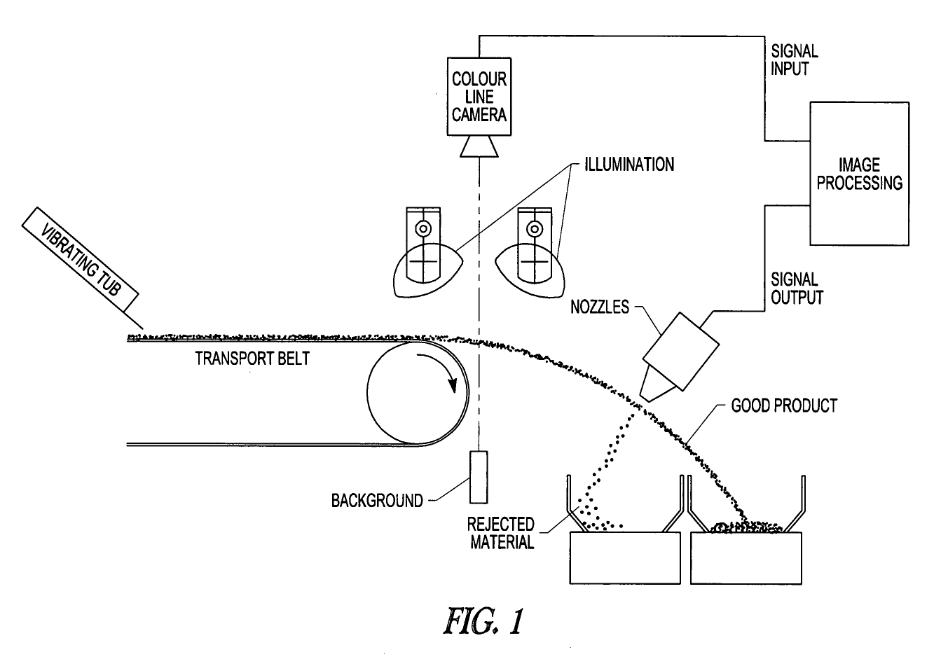

FIG. 1 now shows firstly the main components of a bulk material sorting. The corresponding components can be used individually (e.g., independently of other shown components) or also together also within the scope of the present invention.

In this representation, the bulk material is transferred via a vibration channel (vibrating tub) to a conveyor belt or transport belt. Both the transport of the bulk material via the vibration channel and the transport via the conveyor belt both serve to separate the bulk material such that the objects of the bulk material no longer overlap or touch when they are detected by the optical sensor after discharge from the conveyor belt.

The bulk material is illuminated here uniformly from above by a light perpendicular to the direction of movement. This is generally desired since the optical sensor likewise looks from above onto the bulk material and a well defined background. According to examples, the bulk material can be recorded also from the other side (from the bottom) or simultaneously from both sides (e.g., both from the top and from the bottom). The optical sensor can include either a surface or a line sensor (e.g. CCD camera). In the case of a line sensor, an endless two-dimensional image is produced by the movement of the bulk material, which image, in uniform portions of for example a few hundred or thousand lines, is conducted further for evaluation to the image processing unit. In the image processing unit, the classification into good and poor, e.g., into desired product and into undesired foreign bodies, is implemented. This information then actuates a series of valves at the correct time and at the correct location such that undesired material is rejected: each valve can be connected for this purpose to at least one nozzle which in turn are disposed for example parallel to the visual range of the optical sensor and ensure expulsion of the rejected material out of the discharged bulk material jet.

In order that the classification provides unequivocal results with respect to for example geometry, shape and/or colour of the bulk material (in particular if a colour line camera is used), a constant transport speed and a lack of intrinsic speed (e.g., speed relative to the surface of the conveyor belt) of all objects on the transport belt is useful since the scanning rate of the optical sensor is always constant. If in contrast the speed varies or intrinsic speeds occur, then several effects occur which reduce the sorting quality to a significant degree, these effects with (colour) line sensors making themselves particularly clearly noticeable:
if the speed is less (greater) than the provided speed, objects become (smaller), e.g., the image processing calculates a larger (smaller) total surface area of the object than this has in reality. Faulty classifications take place consequently.
if the speed is less (greater) than the provided speed, the nozzles emit the blast of air for the sorting too early (too late). As a result, foreign bodies which have not been sluiced out reach the container of the “good” product and good material reaches the container for foreign bodies. Hence faulty sorting is implemented.
when using colour line cameras with a trilinear sensor, false colours are produced if the sensor is constructed such that the sensors for red, green and blue are disposed in parallel at a constant spacing. However, this is a very common type of construction of colour line sensors. If the speed of the bulk material objects is not coordinated with the delay times by the sensor spacings, then the red-green-blue information from one and the same surface unit of the bulk material object is not assigned to a single image point but smudged over a plurality of image points. This leads to so-called rainbow effects since the colour information, as with a rainbow, is visible in the form of separate spectral ranges.

Devices and methods, even with bulk materials with a low density, low weight and/or flat shape (e.g., in particular in the case of bulk materials such as for example tobacco leaves which have significantly different air resistances and consequently different transport speeds during the image recording and sorting), can be intended to counteract the above-portrayed problems, e.g., can be intended to have a stabilising effect on the light materials to be transported.

For example, DE 10 2004 008 642 A1 shows a device for removing foreign materials, which is disposed directly above a conveying element which accelerates the material flow in order to remove foreign materials. At the end of this unit (before the material discharge), an airflow is produced by means of two conveying elements or conveyor belts which are disposed one above the other, said airflow serving for the purpose of holding a monolayer of the transported material on the lower conveying element or conveyor belt. The airflow produced between the two conveyor belts reduces the air resistance during transport in the case of light bulk materials and hence leads to a more uniform transport speed over the conveyor belt width. The airflow produced hence assists reduction in air resistance and ensures a more constant discharge speed.

In another example, DE 697 34 198 T2 comprises a stabilising system and in the case of which a tunnel is formed by means of a transport belt which is inserted above the material for transport. This tunnel and the stabilising system make it possible that, in the tunnel, e.g., between hood underside and upperside of the transport belt, a flow is formed from a fluid (air) which moves over the length of the belt and along the latter. As a result of the described arrangement, more predictable and more homogeneous flow ratios are produced so that a sorting station connected to the tunnel can treat the materials or objects to be sorted more precisely. The light bulk material then has a constant discharge speed and a predictable trajectory so that foreign bodies can be excluded specifically. Three measures are essential with this device: there must be an airflow in the region of the material feed (and in fact in the direction of the transport or movement direction of the belt), the conveyor belt must be covered in order that the tunnel is produced (from which no air can escape) and the discharge region must be surrounded completely by a hood portion.

Such devices display however speed distributions over the conveyor belt and in the region of the material discharge, which are configured such that the air speed varies parallel and perpendicular to the transport or movement direction still to a significant degree and deviates significantly from the conveyor belt speed. As a result of such variations or deviations from the conveyor belt speed, the light materials are still subjected to an intrinsic movement (because of the forces resulting from the speed variations and deviations) so that no uniformly constant transport and no constant sorting quality can be produced here either.

This document describes how to make available a conveying system (or a corresponding conveying method), with which different conveying speeds, in particular of light materials or bulk materials, can be counteracted, with which a constant transport speed for all the bulk material can be achieved and with which hence a constant and predictable sorting quality can be achieved.

This can be achieved by a conveying system according to claim 1 and also by a conveying method according to claim 16. Advantageous embodiments of the conveying system or conveying method can be deduced respectively from the dependent patent claims. Uses according to embodiments of the invention are described in claim 17.

Examples of the present invention are firstly described subsequently in general, then described in the form of a detailed embodiment. The individual device elements which are used within the scope of the embodiment or the construction thereof can thereby be inserted or used within the scope of the present invention (which is defined by the appended patent claims) also in combinations other than the combination which is shown. Some of the shown elements can therefore be produced also independently of other individual shown elements within the scope of the present invention. In particular, an embodiment of the present invention, as already described above, can be produced also in combination with some of the elements shown in FIG. 1 (for example: colour line camera and image processing unit).

An example of the present invention, in order to transport the bulk materials smoothly and at a constant speed, can insert, in addition to the conveying element (e.g. conveyor belt; subsequently also termed first conveying element) which is used for the material transport or bulk material transport, a further conveying element (subsequently also termed second conveying element or conveyor belt) which is mounted preferably above the first conveying element (or also laterally thereof) and which is moved preferably at precisely the same speed as the conveying element used for the material transport. The further (second) conveying element then has transverse ribs which are disposed preferably perpendicular to the transport direction, which ribs are configured such that the material disposed on the first conveying element (used for the material transport) is situated in moving or moved compartments which are separated from each other by the transverse ribs (subsequently also termed containers) and is transported uniformly. The compartments or containers are closed by suitable configuration of the transverse ribs, of the two conveying elements and/or by lateral walls disposed on the latter preferably almost completely or in fact completely (without air gaps or the like).

A conveying system according to an embodiment of the invention for transporting bulk material therefore comprises a first conveying element which is configured to receive the materials and to transport the same in a transport direction (belt running direction) and can be moved in the transport direction and a second conveying element which can be moved in the same direction thereto (or relative to this conveying element), e.g., likewise in the transport direction, and is disposed at a spacing from the first conveying element. In an example, the second conveying element is provided with a plurality of transverse ribs which can be moved with the second conveying element in the transport direction, which transverse ribs are formed and disposed on the second conveying element such that they cover the first conveying element on the side thereof configured to receive the bulk material and, together with this side, form compartments which are separated from each other and can be moved by moving the two conveying elements in order to receive and transport the materials.

In an embodiment of the present invention, precisely no airflow is present with respect to function on the material feed side and along the conveying stretch between the two conveying elements.

In a first embodiment variant, one or both of the conveying elements concern conveyor belts or transport belts (in particular endless belts). These are then disposed preferably parallel to each other and at a spacing from each other and also extending or moveable in one and the same transport direction. The two conveyor belts can thereby be disposed perpendicularly one above the other or laterally adjacently.

When the two transport belts are disposed one above the other, there is formed thus between the upper side of the lower transport belt (material receiving side) and the lower side of the upper (second) transport belt an intermediate space with a constant spacing. The transverse ribs are then disposed on the upper transport belt and protrude from the lower side of the upper transport belt downwards, e.g., in the direction of the first transport belt or the upper side thereof, so far that the mentioned intermediate space is filled by the protruding transverse ribs virtually completely or completely (the transverse ribs then extend from the upper side of the lower transport belt to the lower side of the upper transport belt, said transverse ribs being mounted on the latter and being moved with the latter in the transport direction).

The two conveying elements or conveyor belts are thereby configured for particular preference such that they are moved at an identical speed in the transport direction. The individual transverse ribs can thereby be fixed rigidly on the second conveyor belt, however it is also possible to fix them detachably on this conveyor belt so that simple exchange is possible for example of defective transverse ribs.

The individual transverse ribs are thereby preferably orientated perpendicular to the transport direction (the transverse ribs or transport element can be configured for example as rectangular plates made of hard rubber or the like) and also are perpendicular to the transport plane (the transport plane is the plane in which the materials are transported, e.g., corresponds in general to the upper surface of the upper portion of the lower, first transport belt). It is however also possible to dispose the individual transverse ribs at a different angle than 90° to the transport direction, e.g., for example, at an angle of 75° to this direction (e.g., inclined slightly diagonally).

Viewed in the transport direction, adjacent transverse ribs are thereby advantageously disposed respectively at a constant spacing from each other on the second conveying element.

As an alternative to the arrangement of two transport belts or conveying elements one above the other, it is however also possible to dispose two such conveying elements or transport belts parallel to each other and laterally adjacently at the same height. The transverse ribs then protrude laterally beyond the upper surface of the second conveying element in the direction of the first conveying element so far that they subdivide the space above the surface of the first conveying element into the individual moved compartments with which then the material transport takes place. Just as in the variant with conveying elements or belts disposed one above the other, the individual transverse ribs can thereby be configured over the entire width of the surface of the first conveying element (e.g., their extension perpendicular to the transport direction).

Lateral walls can then be configured at the side on the first and/or on the second conveying element, which side walls, together with the transverse ribs and the surface of the first conveying element carrying the material (and also possibly with the lower side of a second conveying element which is disposed above the first conveying element and carries the transverse ribs, form the partially or entirely closed, moved compartments for transporting the materials.

It is thereby particularly preferred to enclose the compartments on all sides by means of (perpendicular to the transport direction and viewed in the transport plane) lateral walls which are disposed on both sides of the conveying elements/element. It is thereby particularly advantageous to configure the lateral walls on both sides of the first conveying element. The lateral walls can thereby be configured in a stationary manner laterally adjacent to the first conveyor belt (so that this conveyor belt is moved along between the lateral walls), however it is also conceivable to configure suitable (e.g. collapsible or foldable) wall elements which are fixed on the moved first conveying element or parts of the same and hence are moved jointly with the latter.

In the variant with adjacently disposed conveyor belts, it is also possible to dispose lateral walls, e.g. in that the transverse ribs have corresponding recesses in order to be able to guide them away via a lateral wall disposed between the two conveyor belts.

In a further advantageous variant with conveying elements situated one above the other, the second upper conveying element has on the discharge side of the material (e.g., at the end of the belts viewed in the transport direction) an inclination (viewed in the transport direction) which is directed away from the first conveying element. Thus the belt end of the lower belt portion of the second conveyor belt can be inclined upwards.

In a further variant with conveyor belts disposed one above the other, these are of different lengths, viewed in the transport direction, the upper conveyor belt being shorter than the lower and a hood which covers the first conveying element being disposed in the protruding region above the first conveying element on the material discharge side.

In order to reduce even further still occurring, slight differences in the speed of the transported material and the speed of the first conveying element, it is possible to dispose a device for producing an airflow in the discharge-side region on the material discharge side, in particular viewed in the transport direction behind the material discharge edge. This device can be configured in particular as an air suction device with controllable air suction flow or with controllable suction speed of the air being suctioned out.

In a particularly advantageous variant, it is possible to configure this device for producing the airflow combined with a blow-off container for poor material or a container for good material. The air suction device can then suction out the air through one such blow-off container or container for good material and thus further minimise the above-mentioned speed differences with suitable control.

According to an embodiment of the invention, light bulk material can hence be transported via a supply unit to a rapidly (e.g. at 3 m/s) running conveyor belt (first conveying element). By means of the second conveying element (which is disposed extending advantageously above and parallel to the lower first conveyor belt), the bulk material can then be enclosed during transport in compartments or containers. This takes place in that the upper conveyor belt has transverse ribs at any, but defined, spacings. The spacings can be advantageously between 100 and 200 mm. The spacing of the upper from the lower conveyor belt can be for example 30 mm (correspondingly the height of the separated compartments). At a 100 mm spacing of adjacent transverse ribs and a height of 30 mm, there results thus with a sorting width of e.g. 700 mm (width of the conveyor belts in the transport plane and perpendicular to the transport direction T) e.g. a compartment volume of 2,100 cm³.

These transverse ribs then surround the bulk material on the material feed side and transport it (quasi closed) in the container until just before the end of the lower conveyor belt. The upper conveyor belt thereby extends advantageously not up to the end, e.g., up to the deflection roller on the discharge side, horizontally, but is inclined slightly upwards at this end. The angle of inclination can thereby be between 5° and 25°, preferably between 10° and 15° (e.g. at 13°). This inclination serves to disturb the bulk material which has contact with a transverse rib as little as possible, as a result of the movement of the transverse rib about the deflection roller of the second conveying element or as a result of a corresponding angle movement.

Optionally, the region above the lower conveyor belt can be covered on the discharge side in addition by a hood. The region between the upper conveyor belt and the lower conveyor belt (with the transverse ribs “running” therein) and also with the optional lateral walls and the subsequent end portion of the lower conveyor belt together with covering hood then forms a tunnel, in particular in the region from which the transverse ribs of the upper belt have the minimum spacing, measured horizontally, from the discharge edge of the lower conveyor belt.

If a transparent hood is applied, a symmetrical light which extends parallel to the discharge edge can be mounted. Hence the line of sight of the line camera extends between the parallel lights situated one opposite the other. Hence no bright field illumination (see further on in this respect) by means of beam splitters is necessary (a silvered beam splitter, because of its function, allows only 50% of the radiated and 50% of the reflected light through, the image quality is consequently reduced, which should be avoided).

An advantageous hood geometry is represented by a glass plate which extends horizontally, parallel to the lower conveying element and ends directly in front of the region of the line of sight of the camera. As a result, the light bulk material is guided in a virtually closed channel from the location of the opening of the containers to the location for testing by the camera. External influences, which would occur e.g. with the lack of a hood and would be manifested in an intrinsic movement of the bulk material, are hence minimised. Directly behind the line of sight, a hood construction can begin again in order that the product flow is guided further as smoothly as possible behind the discharge line from the conveyor belt. Therefore the hood construction is adapted to the projection parabola for a prescribed conveying speed, e.g. 3 m/s.

Advantageously, the lower conveyor belt has lateral delimitations or lateral walls which then form the lateral walls of the moving compartments or containers (the transverse ribs form the front and rear wall of such a container, and the upper and lower conveyor belt of the conveyor belt form the upper and lower side of a container).

Should, in the case of light material, the influence of external forces which act on the bulk material as soon as the container is no longer closed (since the transverse ribs open the container front side on the discharge side) be so great that such a material still has a measurable speed other than that of the lower conveyor belt or of the two conveyor belts, this influence can still be reduced further by producing an airflow with the above-described device (e.g. suction device).

Such an airflow can be produced in that the air is suctioned in variably adjustably behind the discharge edge. This can be produced for example in that the air is suctioned through a blow-off container (into which poor material is thrown) or in that the air is suctioned in through that container which contains the bulk material.

The suction control should be regarded in the context of blowing off foreign bodies. Suction which is controlled as a function of the actuated valves is advantageous. It has thereby proved to be advantageous to apply the suction in the lower region of the blow-off basket.

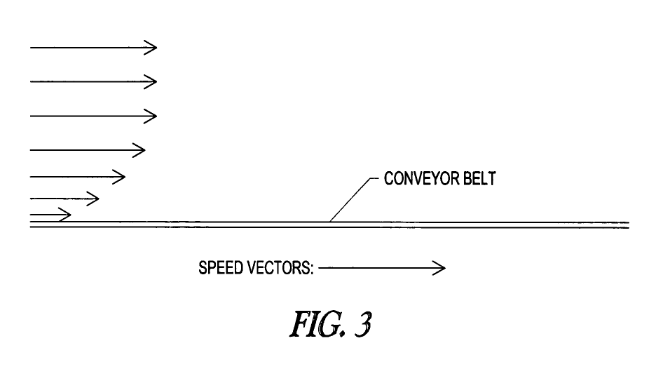

Relative to certain other conveying systems, embodiments of the present invention can have a series of advantages:
as a result of the fact that the material and the surrounding air with the help of the transverse ribs are situated in a quasi closed region (compartment), the light material, despite the movement by the conveyed material or the first conveying element, experiences no air resistance or contrary wind. As a result of the absence of this air resistance, the bulk material lies still on the conveyor belt hence without any intrinsic movement.
as a result of the described constructional features, speeds vertical to the conveying direction which are in particular also location-dependent are avoided. Such flow speeds are impressed upon light bulk material in particular by two conveyor belts running parallel without transverse ribs and caused in that the air between such conveyor belts is entrained merely by the two belts themselves. FIG. 3 shows the flow speed of the air schematically near the conveyor belt in such a case with reference to vectors (flow profile close to the lower conveyor belt): such a parabola of the speed vectors exists in the case without transverse ribs since here gases flow between two flat “plates” at a laterally constant speed. In the case of an extended light object, the speed differences have an effect however such that one and the same object experiences different pulse sizes on different surface elements which lead to the fact that the object is moved and hence has a different speed from the conveyor belt (intrinsic speed). Precisely such vertical speed differences which cause intrinsic movements with extended objects can however be prevented with some embodiments of the present invention.
as a result of the fact that the bulk material and the air are transported in compartments (closed system) they are not subject to external forces, as a result of which the light bulk material is transported without an intrinsic movement at the speed of the conveyor belt.
shortly before reaching the discharge edge, the compartment is then opened in that for example the upper belt is inclined slightly upwards. In such a last short portion, slight external forces can thereby still act on the light bulk material but have only a minimal effect since, because of the short stretch to the discharge and the mass inertia (even if the latter is only small), the influence of these parameters is no longer significant.
should the influence with individual bulk materials indeed still be measurable, the additional suctioning of the air can serve for the purpose of the external forces having no negative effects on the movements of such bulk material.

Embodiments of the present invention can hence be used in particular for conveying light bulk materials, such as for example cut materials in the form of tobacco or spices which are intended, when leaving the conveying unit, to have an arbitrary but constant speed.

In the accompanying FIGS. 1 to 3 there are shown:

FIG. 1 a conveying system which can be used within the scope of the present invention;

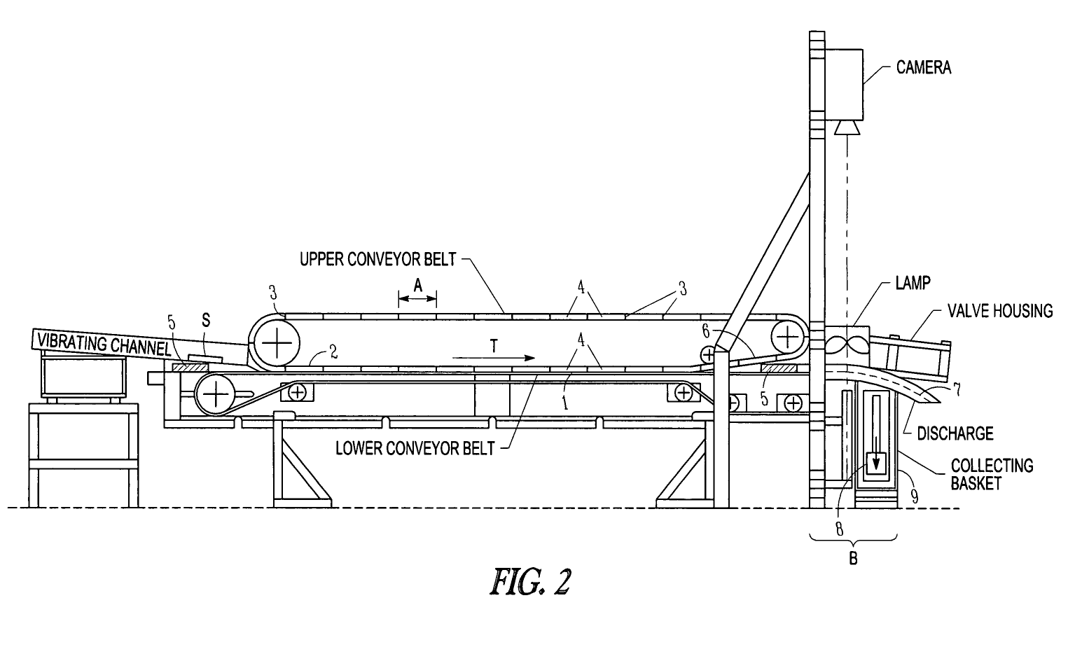

FIG. 2 an embodiment of a conveying system according to the invention in a sectional view in the transport direction and perpendicular to the transport plane;

FIG. 3 a diagram relating to the speed ratios in certain conveying systems.

FIG. 2 shows an embodiment of a conveying system according to the invention in cross-section in the transport direction T perpendicularly through the transport or conveying plane.

Via a vibration channel, bulk material S is guided onto the upper surface of a first, lower conveyor belt 1. This conveyor belt 1 is configured as an endless transport belt, the upper belt portion thereof extending horizontally in the transport plane in the transport direction T.

There is disposed parallel to the lower conveyor belt above the lower conveyor belt and at a spacing from the upper side of the lower conveyor belt 1 a further conveying element in the form of an upper conveyor belt 2 which is configured likewise as an endless belt. The upper conveyor belt 2 is thereby disposed likewise in the horizontal direction and such that the lower belt portion of the upper conveyor belt 2 has, over the entire length in the transport direction T (apart from the end portion, see later), a constant defined spacing from the upper belt portion of the lower conveyor belt 1. The upper belt portion of the belt 1 and the lower belt portion of the belt 2 run at the same speed in the transport direction T.

The upper conveyor belt 2 now has, on the outer circumferential side, a large number of individual transverse ribs 3 which are disposed at constant spacings A relative to each other. The individual transverse ribs 3 are fixed on the upper conveyor belt 2 transversely relative to the transport direction T such that they cover the entire width thereof and protrude perpendicularly from the latter. The transverse ribs 3 disposed on the lower belt portion of the upper conveyor belt are hence orientated perpendicular to the transport plane and perpendicular to the transport direction T.

The height of the individual transverse ribs 3 is thereby configured such that the intermediate space between the upper belt portion of the lower conveyor belt 1 and the lower belt portion of the upper conveyor belt 2 are filled practically completely. Laterally beside the lower conveyor belt, lateral walls 5, merely indicated here, are disposed perpendicular to the transport plane and in the transport direction T. These have a height or extension perpendicular to the transport plane, which corresponds at least to that of the transverse ribs 3, and cover the above-mentioned intermediate space.

By means of the upper side of the upper belt portion of the lower conveyor belt 1, the lower side of the lower belt portion of the upper conveyor belt 2, the transverse ribs 3 and the lateral walls 5, a large number of individual compartments 4 is hence configured between the two conveyor belts, said compartments moving, because of the movement of the conveyor belts and of the transverse ribs, at a speed in the transport direction T corresponding to the feed speed of the conveyor belts. These compartments 4 are hence quasi sealed containers in which the bulk material S, as described above (because of the lack of air resistance by corresponding joint movement of the air in the compartments 4), can be transported at a speed corresponding to the speed of the conveyor belts in the feed direction T, i.e. without additional speed components relative to the belt surfaces. The two conveyor belts 1 and 2 have for this purpose one and the same speed in the transport direction T.

On the discharge-side end (on the right in the picture), the lower belt portion of the upper conveyor belt 2 (viewed in the transport direction T) towards the end of the upper conveyor belt 2 has an inclination 6 which is directed away from the surface of the upper belt portion of the lower conveyor belt 1. The angle of inclination here is approx. 13°.

At the discharge-side end, the lower conveyor belt 1 protrudes beyond the upper conveyor belt 2; between the discharge-side end of the upper conveyor belt and that of the lower conveyor belt, there are disposed, above the lower conveyor belt, the lamps which serve for illumination of the discharge region B and the camera which serves for image recording for the image processing device (cf. FIG. 1) behind the discharge roller of the lower conveyor belt (image recording direction of the camera perpendicular to the transport plane). Viewed in the transport direction, behind it, the valves for controlling the nozzles for rejecting poor material are configured above the lower conveyor belt (cf. FIG. 1).

As described above, the lower conveyor belt is provided here at the discharge-side end with a cover hood 7 which serves for the purpose of external influences hence being minimised, which external influences would arise for example with the absence of a hood and would be expressed in an intrinsic movement of the bulk material. The effect by suction is also controllable due to a hood.

Viewed in the transport direction T behind the lower conveyor belt 1 (i.e. behind the material discharge edge of the lower conveyor belt and below the cover hood 7), a collecting basket 9 (blow-off container for poor material) is disposed. As merely sketched here, an air suction device 8 is integrated in this collecting basket 9, with which device an additional air suction flow can be controlled in the discharge region B in order further to minimise, as described above, still possibly occurring irregularities in the speed of the bulk material S relative to the transport speed of the conveyor belts 1, 2.

The construction shown in the presented example can in particular also be as follows: when using a deflection roller with radius 80 mm, a conveyed material with a thickness of 3 mm and transverse ribs with a height of 30 mm, the inclination can begin 243 mm before the discharge-side end of the lower conveying element. Then the transverse rib is situated after 130 mm directly below the centre of the deflection roller and in fact precisely 30 mm above the lower conveying element. After this time, the transverse rib experiences a rotary movement along the deflection roller. If the transverse rib has moved 90° about the deflection roller, it is situated horizontally and must not protrude into the line of sight of the camera. The spacing of camera line of sight to axis centre of the deflection roller is 113 mm. The line camera is positioned such that it looks directly behind the discharge roller of the lower conveying element onto the discharged product.

The spacing between the beginning of the inclination and the hood edge is 135 mm with the assumption that the hood upper edge is situated 32 mm above the lower conveying element with a glass thickness of 2 mm and an inclination of 13°. Hence the spacing of hood underside from upper edge of the lower conveying element remains the same at 30 mm.

If the upper conveying element together with the conveyor belt with transverse ribs has the minimum spacing from the line of sight of the camera, i.e. precisely such that the transverse rib does not affect the line of sight of the camera in its horizontal position, the illumination, with a so-called vertical illumination, is not applied above the conveying elements since the upper conveying element would be situated in the light cone of the illumination. Vertical illumination illuminates the product on the camera side. Illumination in that case is possible via a bright field illumination, e.g., in that light is radiated into the beam path of the camera via a semi-silvered beam splitter. In addition, illumination can be applied from the discharge side, e.g., in the conveying direction of the camera line of sight.

With a suitable configuration and arrangement of lamp and camera, the material discharge-side end of the upper conveyor belt can also be disposed at the same height as the discharge-side end of the lower conveyor belt (or even protrude beyond the latter, e.g., the upper conveyor belt protrudes on the discharge side beyond the discharge edge of the lower belt and covers the latter). The lower edge of the transverse ribs then extends on the discharge-side end parallel to the discharge edge of the lower conveyor belt.

What is claimed is:

1. A conveying system for transporting materials, the conveying system comprising:
a first conveying element which is configured to receive the materials and to transport the materials in a transport direction and can be moved in the transport direction; and
a second conveying element which can be moved in the same transport direction and which is disposed at a spacing from the first conveying element, said second conveying element being provided with a plurality of transverse ribs which can be moved with the second conveying element in the transport direction, which transverse ribs are formed and disposed on the second conveying element such that they cover the first conveying element on a side thereof configured to receive the materials and, together with the side of the first conveying element, form compartments which are separated from each other in order to receive and transport the materials,
wherein the compartments are surrounded on all sides and closed completely by configuration of the two conveying elements and of the transverse ribs.

2. The conveying system according to claim 1, wherein the first and/or the second conveying element comprises or is part of a conveyor belt, both conveying elements being disposed, extend and/or can be moved parallel to each other and at a spacing from each other.

3. The conveying system according to claim 1, wherein the second conveying element is disposed at a spacing from and above the first conveying element.

4. The conveying system according to claim 3, wherein both conveying elements include endless conveyor belts which are disposed situated one above the other and in which the lower belt portion of the upper, second conveying element and the upper belt portion of the lower, first conveying element can be moved in the same direction in the transport direction and in which the transverse ribs which are disposed on the lower belt portion of the second conveying element protrude from the top into the intermediate space between the lower belt portion of the second conveying element and the upper belt portion of the first conveying element such that they seal this intermediate space from the top to the bottom towards the upper side of the upper belt portion of the first conveying element, so as to receive and to transport materials and hence form the compartments.

5. The conveying system according to claim 1, wherein the second conveying element is disposed at a spacing from and laterally adjacent to the first conveying element.

6. The conveying system according to claim 5, wherein both conveying elements include endless conveyor belts which are disposed laterally adjacently and in which the upper belt portion of the second conveying element and the upper belt portion of the first conveying element can be moved laterally adjacently in the same direction in the transport direction and in which the transverse ribs disposed on the upper belt portion of the second conveying element protrude laterally beyond the second conveying element and protrude from the side into the space above the upper belt portion of the first conveying element such that they subdivide this space at the bottom towards the upper side of the upper belt portion of the first conveying element, so as to receive and to transport the materials, and hence form the compartments.

7. The conveying system according to claim 1, wherein the second conveying element and the first conveying element are configured such that they can be moved at identical speed in the transport direction, wherein the plurality of transverse ribs are fixed rigidly or detachably on the second conveying element, wherein the second conveying element is configured as conveyor belt, such that the ribs can be moved with and/or by the second conveying element in the transport direction.

8. The conveying system according to claim 1, wherein at least one of the transverse ribs is orientated at an angle of greater than 45° relative to the transport direction.

9. The conveying system according to claim 1, wherein viewed transversely relative to the transport direction laterally of and/or on one or on both outer sides of the first and/or of the second conveying element, a lateral wall is configured such that the compartments are sealed laterally on one side.

10. The conveying system according to claim 9, wherein the lateral wall is fixed rigidly or detachably on a lateral edge of a first conveying element configured as endless conveyor belt.

11. The conveying system according to claim 1, wherein a plurality of the transverse ribs are disposed in pairs and, viewed in the transport direction, respectively at a constant spacing from each other on the second conveying element.

12. The conveying system according to claim 3, wherein the second, upper conveying element includes on a discharge side of the materials, an inclination of the lower belt portion of the second conveying element which is directed away from the first conveying element.

13. The conveying system according to claim 3, wherein on a discharge side of the materials, the first, lower conveying element protrudes beyond the second, upper conveying element and in that a hood which covers the first conveying element is disposed in this protruding region above the first conveying element or in that, on the discharge side of the materials, the second, upper conveying element ends at the same height as the first, lower conveying element or projects beyond the latter.

14. The conveying system according to claim 1, wherein on the discharge side of the materials, in the region of the end, situated in the transport direction, of the first and/or of the second conveying element, in particular viewed in the transport direction behind the material discharge edge of a first conveying element configured as endless conveyor belt, a device for producing an airflow in this region is disposed, in particular an air suction device for suction of air, the air being able to be suctioned preferably in the transport direction.

15. The conveying system according to claim 14, wherein the device for producing the airflow is integrated or disposed in or on a blow-off container for poor material and/or in or on a container for good material and/or in that air can be suctioned by this device through such a blow-off container or container for good material, and/or in that the device for producing the airflow can be controlled with respect to the quantity of air, which is produced or suctioned per unit of time, and/or with respect to the speed of the produced air or the air suction speed.

16. A conveying method for transporting materials, in particular bulk material, the method comprising:
providing the materials being disposed on a first conveying element, which is configured to receive the materials and to transport the materials in a transport direction, and being moved in the transport direction,
providing a second conveying element which is disposed at a spacing from the first conveying element being moved in the same direction relative to the first conveying element in the transport direction,
providing the second conveying element with a plurality of transverse ribs which can be moved with the second conveying element in the transport direction, which transverse ribs are formed and disposed on the second conveying element such that they cover the first conveying element on the side thereof configured to receive the materials and, together with the latter side of the first conveying element, form compartments which are separated from each other and in which the materials are received and transported, wherein the compartments are surrounded on all sides and closed completely by suitable configuration of the two conveying elements and of the transverse ribs.

17. The conveying method according to claim 16, comprising assigning the materials to the compartments and transporting the materials in the compartments.
